(19) United States
(12) Patent Application Publication
(10) Pub. No.: US 2016/0068031 A1
(43) Pub. Date: Mar. 10, 2016

(54) PNEUMATIC TIRE WITH POST CURE SEALANT LAYER

(71) Applicant: The Goodyear Tire & Rubber Company, Akron, OH (US)

(72) Inventors: Gabor Kaszas, Akron, OH (US); Michael Joseph Rachita, Canton, OH (US)

(21) Appl. No.: 14/801,870

(22) Filed: Jul. 17, 2015

Related U.S. Application Data
(60) Provisional application No. 62/046,592, filed on Sep. 5, 2014.

(51) Int. Cl. B60C 19/12; B60C 5/14

(52) U.S. Cl. CPC B60C 19/12; B60C 5/14

(57) ABSTRACT

The present invention is directed to a pneumatic tire comprising a radially outer circumferential rubber tread disposed on a supporting carcass, an inner liner rubber layer radially inwardly disposed on the supporting carcass, and a sealant layer adhered to and disposed inwardly of the rubber inner liner layer as a radially inner surface of the tire, wherein the sealant layer comprises 100 parts by weight of an ionomer, and from 100 to 900 parts by weight, per 100 parts by weight of ionomer (phr), of a diluent.

### BACKGROUND

Various methods, sealants and tire constructions have been suggested for pneumatic tires relating to the use of liquid sealant coatings in which the sealant flows into a puncture hole. However, such liquid sealants can flow excessively at elevated temperatures and cause the tire to become out of balance. Also, the liquid sealant may not be entirely operable or effective over a wide temperature range extending from summer to winter conditions. More complicated tire structures which encase a liquid sealant in a vulcanized rubber material can be expensive to manufacture and can also create balance and suspension problems due to the additional weight required in the tire.

Puncture sealing tires also have been further proposed wherein a sealant layer of degradable butyl based rubber, for example, is assembled between unvulcanized tire layers to provide a built-in sealant. By laminating the sealant layer between two or more non-degraded rubber layers, e.g., the tire inner liner and a tire carcass, the sealant layer retains its structural integrity during the vulcanization operation where high pressures are applied to the tire, which would otherwise displace the degraded rubber layer from its desired location. However, the compounds that typically are used in the built-in sealant, e.g., organic peroxide depolymerized butyl based rubber, can generate gases at higher temperature, such as during the tire cure or during tire use, which can result in aesthetically unappealing inner liner blister formation. Aside from being unappealing, such blister formation may allow the sealant to unfavorably migrate away from its intended location. To combat blister formation, the inner liner, for example, can be provided at an increased thickness but this can add to the cost of building a tire.

It is also known to directly apply sealant layers to tires after the cure process, or post cure. Such sealant layers generally are adhesively secured to the exposed surface of the innermost inner liner, and may be tacky and gel-like. Such post cure sealants as known in the art may not provide adequate long term seal against puncturing objects such as nails and the like.

Accordingly, there is a need for an improved post cure sealant layer for tires.

### SUMMARY

The present invention is directed to a pneumatic tire comprising a radially outer circumferential rubber tread disposed on a supporting carcass, an inner liner rubber layer radially inwardly disposed on the supporting carcass, and a sealant layer adhered to and disposed inwardly of the rubber inner liner layer as a radially inner surface of the tire, wherein the sealant layer comprises 100 parts by weight of an ionomer, and from 100 to 900 parts by weight of a diluent.

### DRAWINGS

FIG. 1 shows a cross-sectional view of a pneumatic tire which contains a circumferential sealant layer which contains a post tire cure applied sealant layer adhered to the innerliner.

FIG. 2 shows a partial cross-sectional view of a portion of the tire with a post-tire cure applied sealant layer.

### DESCRIPTION

There is disclosed a pneumatic tire comprising a radially outer circumferential rubber tread disposed on a supporting carcass, an inner liner rubber layer radially inwardly disposed on the supporting carcass, and a sealant layer adhered to and disposed inwardly of the rubber inner liner layer as a radially inner surface of the tire, wherein the sealant layer comprises 100 parts by weight of an ionomer, and from 100 to 900 parts by weight of a diluent.

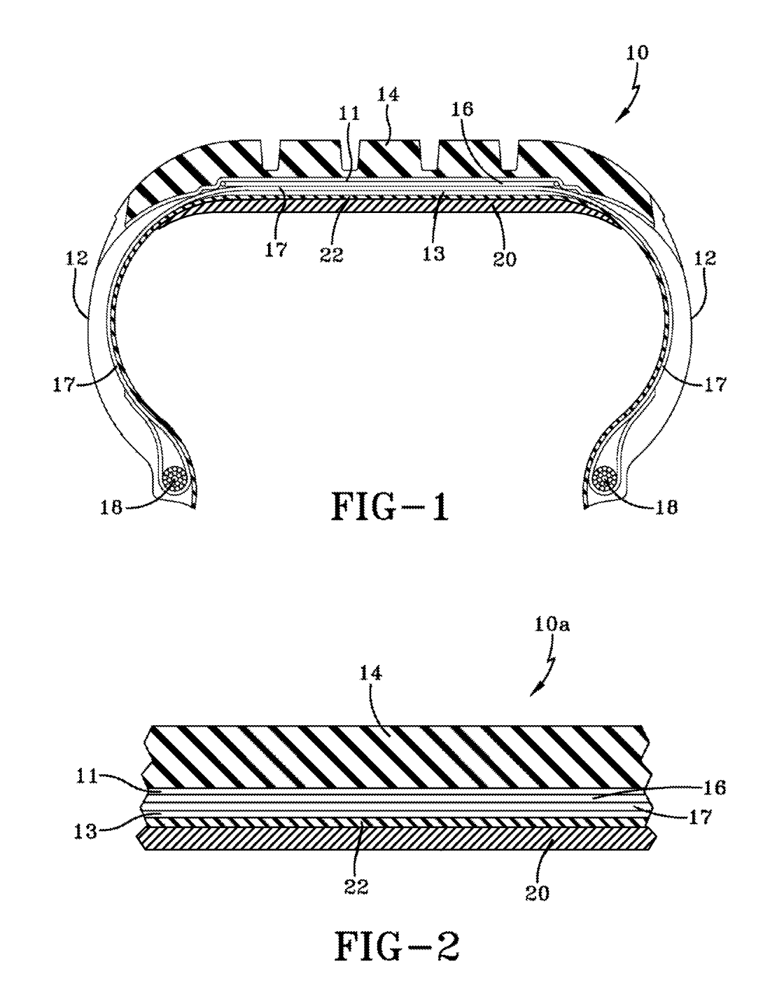

In FIG. 1, a cross-section of a cured pneumatic tire 10 is presented comprised of a tread 14 which includes a tread base rubber layer 11, sidewalls 12, spaced apart beads 18 and carcass underlying the tread 14 (including the tread base layer 11), comprised of cord reinforced (e.g. wire cord reinforced) rubber belt plies 16, cord reinforced (e.g. synthetic nylon or polyester cord reinforced) rubber carcass ply 17 and an optional rubber barrier layer 13 with inner liner rubber layer 22 being positioned radially inward of the carcass and optional barrier layer 13 and carcass ply 17 together with a sealant layer 20 forming the radially innermost surface of the tire. The sealant layer is composition comprising an ionomer and a diluent.

The sealant layer includes an ionomer. Suitable ionomers include halobutyl rubber combined with nitrogen or phosphorus nucleophiles. Thus the ionomer may be described as the reaction product of a halobutyl rubber with a nitrogen or phosphorous nucleophile.

Halobutyl rubber includes bromobutyl and chlorobutyl rubbers. Bromobutyl rubber includes brominated copolymers of C₄ to C₇ isoolefins with C₄ to C₁₄ conjugated dienes and optionally other co-polymerizable monomers. In one embodiment, the bromobutyl rubber is a brominated copolymer of isoprene and isobutylene.

Nitrogen or phosphorus nucleophiles includes compounds of formula I

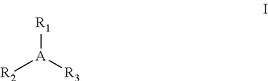

where A is a nitrogen or phosphorus; and R₁, R₂ and R₃ are selected from the group consisting of linear or branched C₁-C₁₈ alkyl substituents, an aryl substituent which is monocyclic or composed of fused C₄-C₈ rings, and/or a hetero atom selected from, for example, B, N, O, Si, P, and S.

In general, the appropriate nucleophile will contain at least one neutral nitrogen or phosphorus center which possesses a lone pair of electrons which is both electronically and sterically accessible for participation in nucleophilic substitution reactions. Suitable nucleophiles include trimethylamine, triethylamine, triisopropylamine, tri-n-butylamine, trimethylphosphine, triethylphosphine, triisopropylphosphine, tri-n-butylphosphine, and triphenylphosphine.

Other suitable nucleophiles include substituted azoles as disclosed in US 2012/0157579. In one embodiment, the nucleophile may be N-butyl imidazole, N-(trimethylsilyl)imidazole, N-decyl-2-methylimidazole, N-hydroxyethyl imidazole, N-(3-trimethoxysilylpropyl)imidazole, N-vinylimidazole, 2-(imidazol-1-yl)ethyl 2-methyl-2-propenoate, 1-butylbenzimidazole, or a combination thereof.

The amount of nucleophile reacted with the butyl rubber may be in the range from 0.1 to 1.5 molar equivalents, more preferably 0.15 to 1.0 molar equivalents based on the total molar amount of allylic halide present in the halobutyl polymer.

The ionomer is present in the sealant in an amount of 100 parts by weight.

In one embodiment, the ionomer is a bromobutyl based ionomer available commercially as X_Butyl™ I4565P from Lanxess.

The sealant layer also includes a diluent. Suitable diluents include low molecular weight elastomers with a number average molecular weight Mn ranging from 500 to 10,000. Low molecular weight elastomers include low molecular weight polyisoprene, polyisobutylene, polybutadiene, butyl rubber, and the like. Suitable diluent is miscible, or viscoelastically compatible with the ionomer. The diluent is present in the sealant in an amount ranging from 100 to 900 parts by weight, per 100 parts by weight of ionomer. In one embodiment, the diluent is present in the sealant in an amount ranging from 200 to 600 parts by weight, per 100 parts by weight of ionomer.

In one embodiment, the diluent is a polybutene. By polybutene, it is meant a polymer of one or more butene isomers including 1-butene, 2-butene, and 2-methylpropene (isobutylene). The polybutene may be commercially referred to as polyisobutylene.

Such polybutenes preferably have a number average molecular weight exceeding about 1000 to minimize the possibility of migration from the sealant layer into adjacent tire components. It is preferably prepared by polymerizing an isobutylene rich stream with a metal halide catalyst and preferably has a polymer backbone structure resembling polyisobutylene. Very suitable polybutenes are available under the trademark Indopol. In one embodiment, the number average molecular weights (Mn) of the polybutene from about 1000 to about 2500, as determined by vapor pressure osmometry.

In one embodiment, the polybutene is present in the sealant in an amount ranging from 100 to 900 parts by weight, per 100 parts by weight of ionomer (phr). In one embodiment, the polybutene is present is an amount ranging from 200 to 600 parts by weight, per 100 parts by weight of ionomer.

Generally, the total elastomer in the sealant will comprise the ionomer and diluent.

Oils may be included in the sealant as a viscosity modifier. Suitable oils include oils such as mineral oils including but not limited to aromatic oils, naphthenic oils, paraffinic oils, MES oils, TDAE oils, RAE oils, and SRAE oils, and vegetable oils including but not limited to sunflower oil, soybean oil, corn oil, castor oil, and canola oil.

Resins may also be included in the sealant as a tackifier. Suitable resin include hydrocarbon resins, phenol/acetylene resins, rosin derived resins and mixtures thereof. Representative hydrocarbon resins include coumarone-indene-resins, petroleum resins, terpene polymers and mixtures thereof. Phenol/acetylene resins may be derived by the addition of acetylene to butyl phenol in the presence of zinc naphthlate. Additional examples are derived from alkylphenol and acetylene.

The sealant composition may be cured by crosslinking during the mixing process in order to achieve additional structural strength of the composition. This can be achieved by crosslinking the allylic halide units which have not been converted to ionomeric units. Alternatively it is possible to add small amounts of regular butyl to the composition with the purpose of providing additional crosslink points to adjust the viscosity of the composition.

There are numerous cure system available to crosslink the remaining allylic halide units of the ionomer. These are crosslinking them by sulfur alone, magnesium oxide, by the use of ZnO in combination of a fatty acid such as stearic acid, by peroxide alone such as dicumyl peroxide or using peroxide in combination with multifunctional coagents, such as 1,3 butylene glycol dimethylacrylate, zinc diacrylate, trimethylol propane trimethacrylate, triallyl trimesate, N,N′-m-phenylenedimaleimide. Crosslinking of allylic halide units can also be achieved by the use of primary or secondary aliphatic or aromatic amines or primary or secondary amine containing trialkoxy silanes, such as gamma-aminopropyl-triethoxysilane. It is also known to the art that higher degree of state of cure can be achieved by the combination of ZnO with aromatic amines such as diphenylamine, diphenyl-p-phenylenediamine, p-octyldiphenylamine, and the low temperature addition product of diphenylamine and acetone. It is also known that the crosslinking of the halobutyl can be achieved by the use of bifunctional dienophyles alone such as N,N′-m-phenylenedimaleimide.

Crosslinking of the regular rubber constituents may be effected by one of the known sulfur or quinoid systems. In the quinoid curing system, p-quinone dioxime and p,p-di-benzoylquinone dioxime are preferred as the curing agents. Other suitable curing agents include dibenzoyl-p-quinone dioxime, p-dinitrosobenzene and N-methyl-N,4-dinitrosoanilene. The crosslinking activators which may be employed in the sealant composition include organic peroxides (including diaryl peroxides, diacyl peroxides and peroxyesters. In one embodiment, the curing agent/crosslinking activator combination is p-quinone dioxime and benzoyl peroxide combination. The preferred concentration of p-quinone dioxime is 2-4% by weight of regular butyl rubber. The preferred concentration of benzoyl peroxide is 7-10% by weight of regular butyl rubber.

Other conventional compounding ingredients may be included in the mixing process, including but not limited to filler such as carbon black, silica, and calcium carbonate, antidegradants, colorants, and the like.

Reaction of the nucleophile with the halobutyl rubber may be accomplished for example by combining the nucleophile and rubber in a rubber mixer such as a Brabender internal mixer, conical mixer, extruder, or the like. The halobutyl polymer and the nucleophile can be reacted for about 10 to 90 minutes, preferably from 15 to 60 minutes and more preferably from 20 to 30 minutes at temperatures ranging from 80 to 200° C., preferably from 90 to 160° C. and more preferably from 100 to 140° C. Following reaction and curing, the sealant composition is applied to the innerliner of a cured tire. A suitable process for mixing the sealant and applying to a tire innerliner is as disclosed in U.S. Pat. No. 8,821,982.

FIG. 2 depicts a partial cross-section of the sulfur cured pneumatic tire 10, labeled as 10a in FIG. 2, comprising the tire tread 14 with its tread base rubber layer 11, wire cord reinforced rubber belt plies 16, carcass with synthetic cord reinforced rubber carcass ply 17 (e.g. synthetic fiber based cord such as, for example, nylon or polyester cord), optional rubber barrier layer 13, rubber inner liner 22 and sealant layer 20. The sealant layer 20 is applied to the inner liner 22 of the already cured tire (and is therefore a post tire cure applied sealant layer) to provide a tire with a sealant layer with puncture sealing properties against various puncturing objects.

The thickness of the circumferential sealant layer 20 can vary depending somewhat upon the degree of sealing ability desired as well as the tire itself, including the tire size and intended tire use. For example, the thickness of the sealant layer may range from about 0.13 cm (0.05 inches) to about 1.9 cm (0.75 inches) depending somewhat upon the tire itself and its intended use. For example, in passenger tires, the sealant layer 20 might, for example, have a thickness in a range of about 0.33 cm (0.125 inches) whereas for truck tires, the sealant layer 20 might, for example, have a thickness in a range of about 0.76 cm (0.3 inches). The post cured tire applied sealant layer 20 is generally situated in the crown region of the tire 10, and, if desired, may include colorant so that it is of a non-black color that may contrast with the black colored inner liner, tread, or sidewall so that a tire puncture can be noticed.

The tire inner liner rubber layer 22 may be comprised of a conventional sulfur curable rubber inner liner for use in pneumatic tires. In one example, the rubber innerliner 22 can be a sulfur curative-containing halobutyl rubber composition of a halobutyl rubber such as for example chlorobutyl rubber or bromobutyl rubber. Such halobutyl rubber based inner liner layer may also contain one or more sulfur curable diene-based elastomers such as, for example, c is 1,4-polyisoprene natural rubber, c is 1,4-polybutadiene rubber and styrene/butadiene rubber, or mixtures thereof. The inner liner 22 is normally prepared by conventional calendering or milling techniques to form a strip of uncured compounded rubber of appropriate width. When the tire 10 is cured, the inner liner 22 becomes co-cured and thereby integral with, the tire 10. Tire inner liner rubber layers and their methods of preparation are well known to those having skill in such art.

### Example

In this example, the effect of a sealant composition on the ability to seal a puncture in a rubber sample is illustrated. In this example, the ionomer is formed in situ in the mixer, upon reaction of bromobutyl rubber with the nucleophile triphenyl phosphine. A sealant composition was mixed in a 60 liter conical twin mixer (Colmec CTM-95) with amounts given in Table 1 in phr based on the amount of bromobutyl rubber. The addition sequence is also indicated in Table 1. Bromobutyl rubber was first mixed with magnesium oxide, calcium carbonate and a majority of the polybutene, followed by addition of the triphenyl phosphine and finally the remainder of the polybutene. In the mixer, the diathermic unit was set at 40° C. at start. The batch temperature was kept in the range 105 to 110° C. from the end of the bromobutyl rubber breakdown until the start of the addition of the polybutene. The temperature was then lowered to 85-90° C. and kept in this range by the adjustment of rotor speed.

TABLE 1

| | Amount | | Addition |
|---|---|---|---|
| | (kg) | (phr) | Sequence |
| Bromobutyl 2222 | 18.28 | 100 | 1 |
| Magnesium oxide | 0.58 | 3.2 | 2 |
| Calcium Carbonate | 5.80 | 31.7 | 2 |
| Polybutene¹ | 5.80 | 31.7 | 2 |
| Polybutene¹ | 26.50 | 145 | 3 |
| Triphenyl Phosphine² | 0.59 | 3.2 | 4 |
| Polybutene¹ | 7.45 | 40.8 | 5 |

¹Polyisobutylene as Indopol H-300 from Ineos. Mₙ = 1,300 g/mol.
²Triphenyl phosphine pellets from BASF

### Results of the Sealability Test Conducted at Room Temperature.

A series of holes of various diameter were drilled into a cured rubber mat consisting of sequential layers of tread compound, reinforcement material, and innerliner compound, each layer being 2 mm thick. The rubber mat was cooled with liquid nitrogen before holes with diameters of 1 mm, 2 mm and 3 mm were drilled. Cured sealant compound was dispensed on silicon coated paper which was then cut to the required sample size and transferred to the rubber mat, followed by removal of the paper. Nails with diameter of 5 mm were inserted in the pre-drilled holes. The sample was then pressurized to 2.5 bars, followed by removal of the nails. The holes were then visually inspected immediately after nail removal and 20 hours after nail removal, with results as given in Tables 2 and 3 below.

Samples were cured in a press for 30 minutes at 160° C.

TABLE 2

| Status immediately after nail removal | | | | Status 20 hours after nail removal | | | |
|---|---|---|---|---|---|---|---|
| | Hole # 1 | Hole # 2 | Hole # 3 | | Hole # 1 | Hole # 2 | Hole # 3 |
| Hole 1 mm | sealed | sealed | sealed | Hole 1 mm | sealed | sealed | sealed |
| Nail 5 mm | | | | Nail 5 mm | | | |
| Hole 2 mm | sealed | sealed | sealed | Hole 2 mm | sealed | sealed | sealed |
| Nail 5 mm | | | | Nail 5 mm | | | |
| Hole 3 mm | sealed | sealed | sealed | Hole 3 mm | sealed | sealed | sealed |
| Nail 5 mm | | | | Nail 5 mm | | | |

As seen in Table 2, the sealant successfully sealed all of the nail holes in the test substrate.

What is claimed is:

1. A pneumatic tire comprising a radially outer circumferential rubber tread disposed on a supporting carcass, an inner liner rubber layer radially inwardly disposed on the supporting carcass, and a sealant layer adhered to and disposed inwardly of the rubber inner liner layer as a radially inner surface of the tire, wherein the sealant layer comprises
100 parts by weight of an ionomer, and
from 100 to 900 parts by weight, per 100 parts by weight of ionomer (phr), of a diluent.

2. The pneumatic tire of claim 1, wherein the ionomer is the reaction product of a halobutyl rubber and a nucleophile of formula I 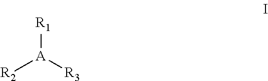
where A is a nitrogen or phosphorus; and R₁, R₂ and R₃ are selected from the group consisting of linear or branched C₁-C₁₈ alkyl substituents, an aryl substituent which is monocyclic or composed of fused C₄-C₈ rings, and/or a hetero atom selected from, for example, B, N, O, Si, P, and S.

3. The pneumatic tire of claim 2, wherein the halobutyl rubber is a bromobutyl rubber.

4. The pneumatic tire of claim 1, wherein the diluent is a low molecular weight elastomers with a number average molecular weight Mw ranging from 500 to 10,000

5. The pneumatic tire of claim 1, wherein the sealant further comprises at least one of oil and resin.

6. The pneumatic tire of claim 1, wherein the ionomer is the reaction product of a halobutyl rubber and an azole.

7. The pneumatic tire of claim 7, wherein the azole is selected from the group consisting of N-butyl imidazole, N-(trimethylsilyl)imidazole, N-decyl-2-methylimidazole, N-hydroxyethyl imidazole, N-(3-trimethoxysilylpropyl)imidazole, N-vinylimidazole, 2-(imidazol-1-yl)ethyl 2-methyl-2-propenoate, 1-butylbenzimidazole, or a combination thereof.

8. The pneumatic tire of claim 4, wherein the diluent is polybutene having a molecular weight Mn ranging from 1000 to 2500.
